(19) United States
(12) Patent Application Publication
(10) Pub. No.: US 2006/0176510 A1
(43) Pub. Date: Aug. 10, 2006

(54) Image data transmission device and image data transmission method

(75) Inventor: Akinori Nishizawa, Otsu-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/268,560

(22) Filed: Nov. 8, 2005

(30) Foreign Application Priority Data
Feb. 4, 2005 (JP) 2005-028379

(51) Int. Cl. G06F 3/12

(52) U.S. Cl. 358/1.15

(57) ABSTRACT

An image data transmission device retrieves data from a Radio Frequency Identification (RF-ID) tag associated with an original document by using an RF-ID reader. The image data transmission device generates first image data from the retrieved data, adds the generated first image data to second image data obtained by scanning the original document, and generates third image data. The image data transmission device transmits the third image data to a destination by facsimile or electronic mail.

### BACKGROUND OF THE INVENTION

1. Field of the Invention

The present invention relates to an image data transmission device and an image data transmission method for transmitting image data of an original document in a facsimile communication or the like.

2. Description of the Related Art

In general, when transmitting an original document by a facsimile machine, a telephone number of a destination is entered by operating a ten-key numeric pad or a speed dial key. In such a type of facsimile machine, to eliminate time and labor for entering a telephone number by operating the ten-key numeric pad or the speed dial key, a proposal has been made to scan characters handwritten in a handwritten part of paper and to execute an Optical Character Reader (OCR) process for extracting the telephone number, and to make a call to the extracted telephone number for transmitting image data of an original document.

The OCR process has a possibility of an error. There exists a drawback that a wrong telephone number is recognized and the original document is transmitted to an unexpected destination. Therefore, it is convenient if data of a destination, a subject, a transmitter and a date or the like is added to an original document by using another means and the data is retrieved electromagnetically and facsimile transmission is carried out.

### SUMMARY OF THE INVENTION

The present invention has been made in order to overcome the problems described above. An advantage of the present invention is to provide an image data transmission method which can eliminate time and labor and avoid erroneous transmission.

According to a first aspect of the present invention, a Radio Frequency Identification (RF-ID) tag is attached to an original document. The original document is scanned optically and data is retrieved electromagnetically from the RF-ID tag. When transmitting image data of the original document, image data is generated in accordance with the data retrieved from the RF-ID tag. Then, the generated image data is added to the image data of the original document and transmitted.

Further, in the present invention, the transmission of the image data includes general facsimile transmission using a Public Switched Telephone Network (PSTN) by the International Telecommunication Union-Telecommunications (ITU-T) Recommendation T.30, and electronic mail transmission in which image data of an original document is attached to electronic mail and the electronic mail is transmitted.

According to a second aspect of the present invention, image data of a cover page that is independent from the original document is generated, and the image data of the cover page is added to the image data of the original document and transmitted.

According to a third aspect of the present invention, image data of a Transmission Terminal Identifier (TTI) is generated, and the TTI image data is added to image data of each page of the original document and transmitted.

According to the above-described aspects of the present invention, a transmission destination, a cover page according to a subject and a TTI are added to the original document just by attaching an RF-ID tag to an original document. As a result, an erroneous recognition and a recognition failure that occurred in the handwritten OCR process can be prevented.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating a schematic configuration of a facsimile machine according to a preferred embodiment of the present invention.

FIG. 2 is a view referenced for describing an original document used in the preferred embodiment of the present invention.

FIG. 3 is a view referenced for describing a cover page image generated by the facsimile machine and an original document image.

FIG. 4 is a flowchart illustrating a scanning operation of an original document carried out by the facsimile machine.

FIG. 5 is a flowchart illustrating the scanning operation of the original document carried out by the facsimile machine along with FIG. 4.

FIG. 6 is a flowchart illustrating a scanning operation of data of an RF-ID tag carried out by the facsimile machine.

FIG. 7 illustrates an example of stored data of the RF-ID tag.

### DETAILED DESCRIPTION OF PREFERRED EMBODIMENTS

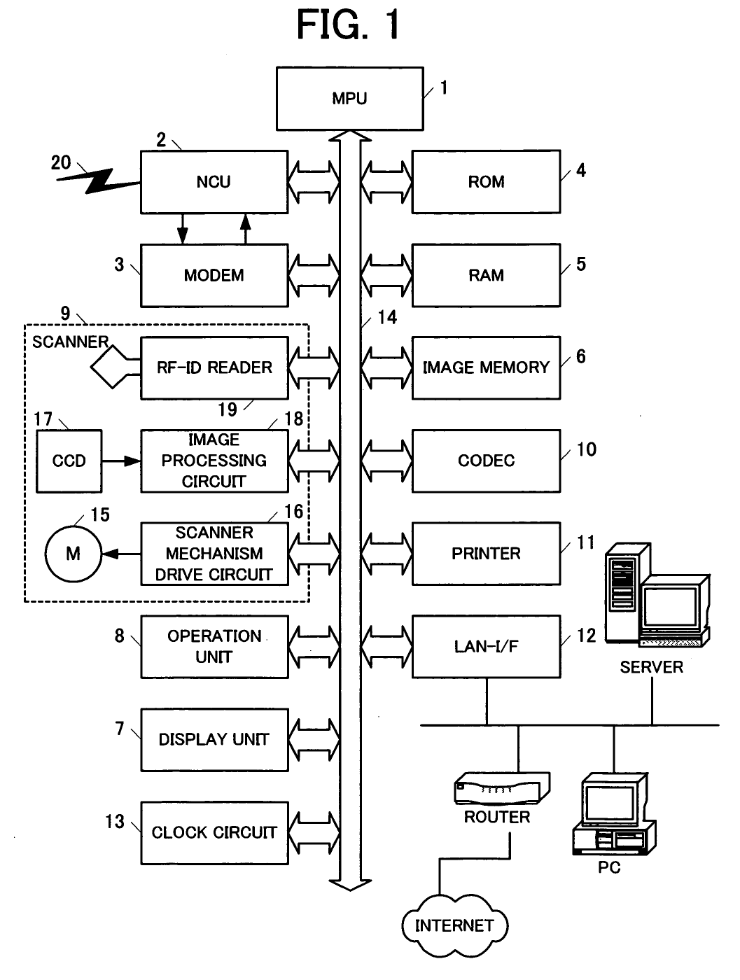

Preferred embodiments of the present invention will be described below. FIG. 1 is a block diagram illustrating a configuration of a facsimile machine according to a preferred embodiment of the present invention. The facsimile machine according to the preferred embodiment includes a Micro Processor Unit (MPU) 1, a Network Control Unit (NCU) 2, a Modulator-Demodulator (MODEM) 3, a Read Only Memory (ROM) 4, a Random Access Memory (RAM) 5, an image memory 6, a display unit 7, an operation unit 8, a scanner 9, a Coder-Decoder (CODEC) 10, a printer 11, a Local Area Network-Inter Face (LAN-I/F) 12, a clock circuit 13 and a bus 14.

The MPU 1 has a function for controlling each component of the facsimile machine in accordance with a program stored in the ROM 4. The NCU 2 has a function for controlling a connection with a telephone line network 20 and transmitting an address signal corresponding to a telephone number of a destination. The NCU 2 also has a function for detecting a ringing signal. The MODEM 3 modulates transmission data and demodulates received data in accordance with V.17, V.27 ter, V.29 or the like based on a facsimile transmission control protocol defined by the ITU-T Recommendation T.30. Alternatively, the MODEM 3 modulates transmission data and demodulates received data in accordance with V.34 in addition to the above-mentioned standards.

The ROM 4 stores a program for controlling the facsimile machine. The RAM 5 temporarily stores data or the like processed by the MPU 1. The RAM 5 stores data scanned from an RF-ID tag 32. The image memory 6 stores received image data or image data scanned by the scanner 9 under an encoded state. The display unit 7 displays information to be notified from the facsimile machine to an operator, for example. The operation unit 8 includes various operation switches, such as a ten-key numeric pad, a fax key, a copy key, a start key, a stop key and a speed-dial key.

The scanner 9 scans an image of an original document when carrying out a facsimile transmission or a copying process. The scanner 9 includes a motor 15, a scanner mechanism drive circuit 16, a Charge-Coupled Device (CCD) line sensor 17, an image processing circuit 18 and an RF-ID reader 19. The motor 15 drives a scanning optical system. The scanner mechanism drive circuit 16 controls a drive of the motor 15. The CCD line sensor 17 scans an original document. The image processing circuit 18 carries out an image processing of an image signal scanned by the CCD line sensor 17. The RF-ID reader 19 scans data of an RF-ID tag. The RF-ID reader 19 is provided appropriately along a document transportation path of the scanner 9. The RF-ID reader l9 may be an RF-ID reader/writer.

The CODEC 10 encodes scanned image data by Modified Huffman (MH), Modified Relative Element Address Designate (MR), Modified MR (MMR) scheme or the like. The CODEC 10 also decodes received image data. The printer 11 prints out image data scanned by the scanner 9 when carrying out a copying process, received image data received by facsimile, and print data transmitted from a remote device such as a Personal Computer (PC). The LAN-I/F 12 is connected to the remote device such as the PC via a LAN. The facsimile machine transmits and receives data to and from the remote device via the LAN-I/F 12. The clock circuit 13 outputs a present time (year, month, day, hour, minute) . Each of the components is connected to one another via the bus 14.

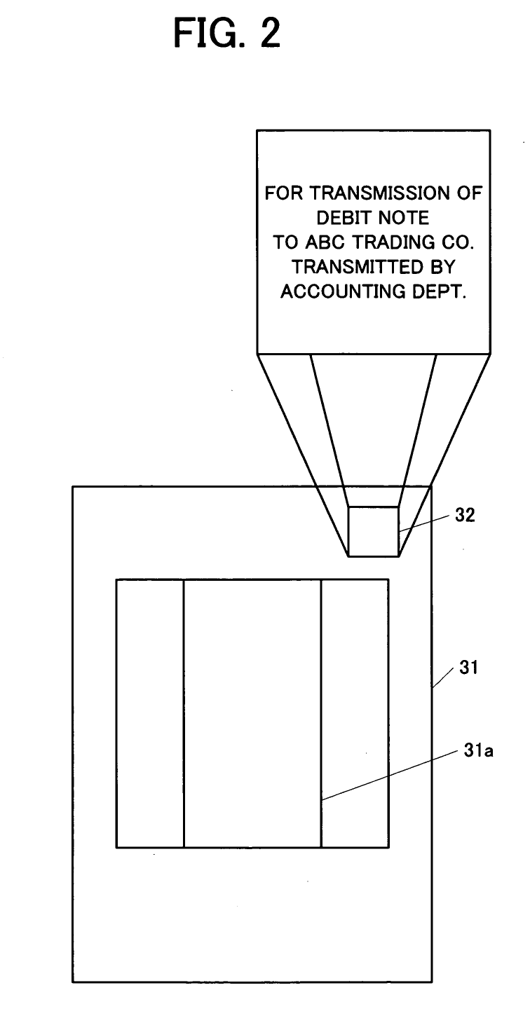

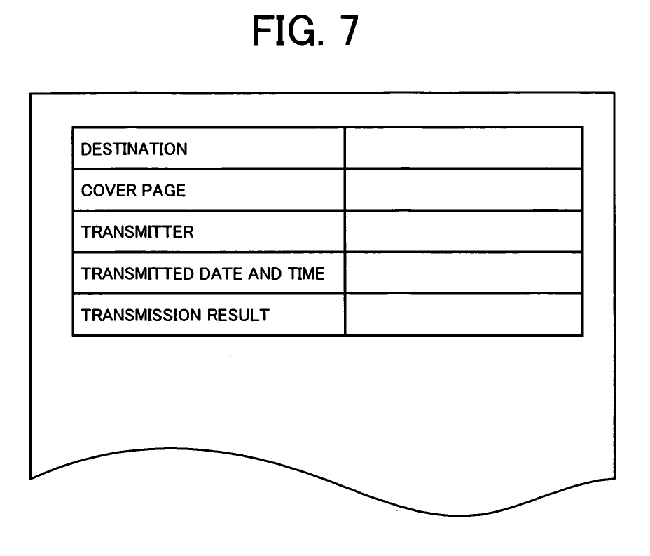

An original document 31 illustrated in FIG. 2 is used for facsimile transmission carried out by the facsimile machine according to the preferred embodiment of the present invention. A passive RF-ID tag 32 is attached on an upper end part of the original document 31. The RF-ID tag 32 is a sheet material on which an adhesive is coated on a reverse side. “Destination”, “subject”, “transmitter (department and name)” or the like are printed on a front side of the RF-ID tag 32. Furthermore, data relating to “destination”, “subject”, “transmitter (department and name)” or the like is stored in a circuit provided inside the RF-ID tag 32. The RF-ID tag 32 may be attached on an appropriate position other than the upper end part of the original document 31. The RF-ID tag 32 can also store “destination”, “cover page”, “transmitter” “transmitted date and time” and “transmission result” as illustrated in an example of FIG. 7. If the RF-ID tag 32 is prepared for each destination to which facsimile is transmitted frequently, the facsimile can be transmitted without operating the ten-key numeric pad, the speed dial key or the like for entering a destination. As a result, convenience of the facsimile transmission improves.

Further, in the present preferred embodiment, the RF-ID tag 32 is attached on the original document 31. However, the RF-ID tag 32 may be sandwiched between carrier sheets and attached onto the original document 31.

When the original document 31 is placed on a document placing part (not illustrated) of the facsimile machine and the start key of the operation unit 8 is operated, an image 31a of the original document 31 is scanned optically by the CCD line sensor 17 and the image processing circuit 18 of the scanner 9. At the same time, data stored in the RF-ID tag 32 of the original document 31 is scanned electromagnetically by the RF-ID reader 19. In accordance with the data (“destination”, “subject”, “transmitter”) retrieved by the RF-ID reader 19, the MPU 1 generates image data. The generated image data is added to image data of the original document 31a and transmitted.

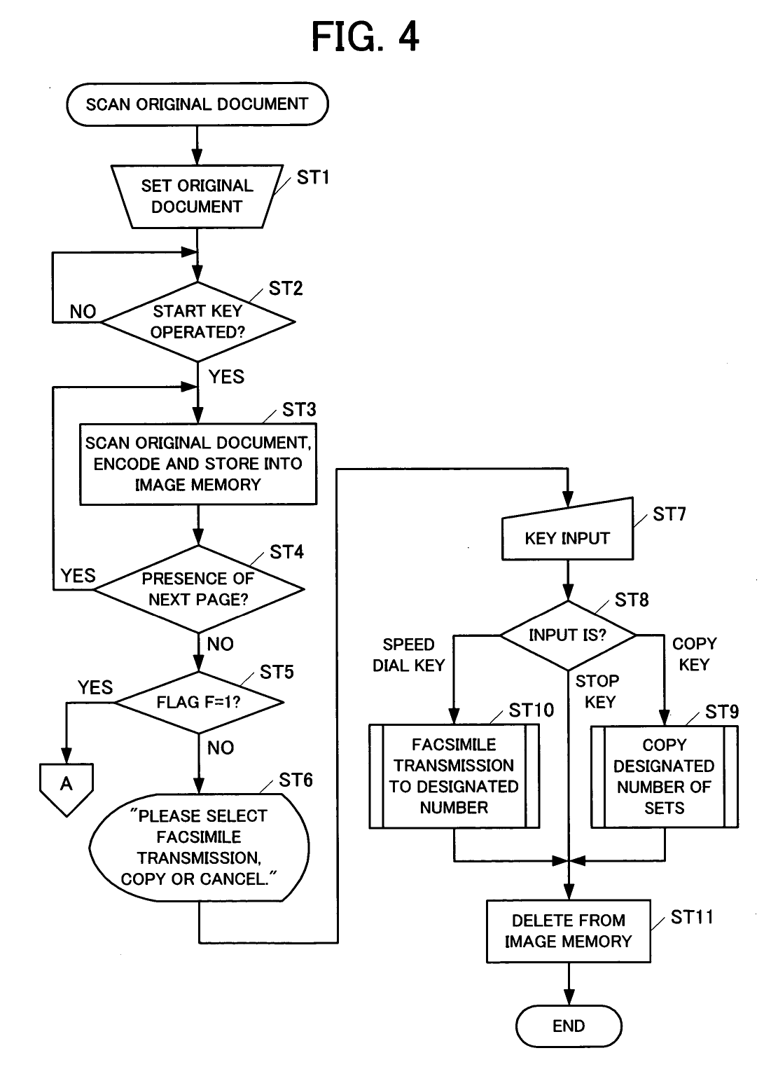

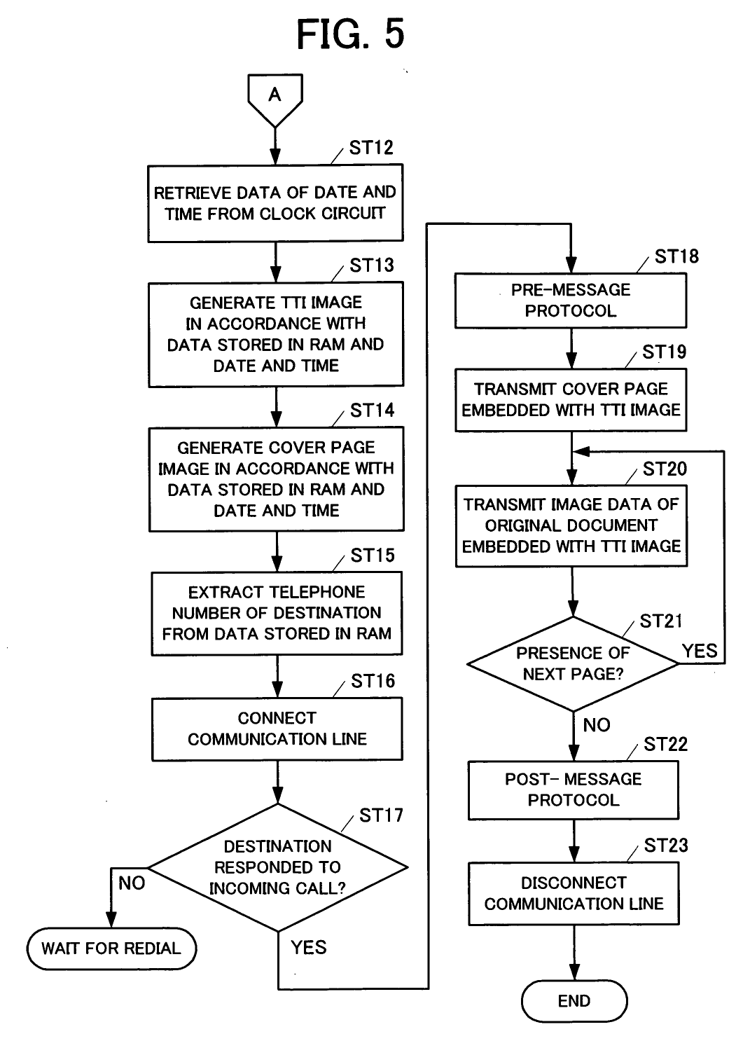

Next, with reference to flowcharts of FIG. 4 through FIG. 6, a description will be made of a processing operation when carrying out facsimile transmission by the facsimile machine according to the preferred embodiment of the present invention. At step ST1, an original document is set on the document placing part of the facsimile machine. Next, the process proceeds onto step ST2. At step ST2, a determination is carried out as to whether or not the start key of the operation unit 8 has been operated. When the start key has been operated, the process proceeds onto step ST3. At step ST3, the original document is scanned by the scanner 9, and image data is encoded by the CODEC 10 and stored into the image memory 6. Next, the process proceeds onto step ST4.

At step ST4, a determination is carried out as to a presence or an absence of a next page of the original document. In case of a presence of a next page, the process returns to step ST3. The next page of the original document is scanned, encoded and stored into the image memory 6. In case of an absence of a next page, the process proceeds onto step ST5. At step ST5, a determination is carried out as to whether or not a flag F is “1”. When F=1, the process proceeds onto step ST12. Meanwhile, when the flag F is not “1” (in other words, when F=0), the process proceeds onto step ST6. The flag F indicates that a stored content of the RF-ID tag 32 has been scanned properly by the RF-ID reader 19. The flag is stored in the RAM 5 as F=1 or F=0.

At step ST6, the display unit 7 displays a message, “Please select facsimile transmission, copy or cancel.” Then, the process proceeds onto step ST7. At step ST7, the operation unit 8 accepts a key input. Then, the process proceeds onto step ST8. At step ST8, a determination is carried out as to whether an input key is the speed dial key, the copy key or the stop key. When the copy key has been operated, the process proceeds onto step ST9. When the speed dial key has been operated, the process proceeds onto step ST10. When the stop key has been operated, the process proceeds onto step ST11. At step ST9, the printer 11 prints out a designated number of sets and executes a copying process. Then, the process proceeds onto step ST11. At step ST10, the scanned image data stored in the image memory 6 is transmitted by facsimile to a telephone number designated by the speed-dial key. Then, the process proceeds onto step ST11. At step ST11, the stored data in the image memory 6 is deleted, and the process ends. Further, a determination of the speed-dial key at step ST8 includes a case where the start key is operated again after the telephone number of the destination has been entered by using the ten-key numeric pad. The above-described processes of step ST6 and onwards are normal processes carried out when the RF-ID tag 32 is not attached or when the RF-ID tag 32 has not been scanned properly.

At step ST12, data relating to date and time is retrieved from the clock circuit 13. Then, the process proceeds onto step ST13. At step ST13, the MPU 1 generates a TTI image in accordance with the data stored in the RAM 5 and the date and time. Next, the process proceeds onto step ST14. At step ST14, a cover page image is generated in accordance with the data stored in the RAM 5 and the date and time. Then, the process proceeds onto step ST15. At step ST15, a telephone number of a destination is extracted from the data stored in the RAM 5. Next, the process proceeds onto step ST16. At step ST16, a communication line is connected, and a dial is made to the extracted telephone number of the destination. Then, the process proceeds onto step ST17.

At step ST17, a determination is carried out as to whether or not the destination has responded to an incoming call. That is, a determination is carried out as to whether or not the destination has responded to the call. When the destination does not respond to the incoming call, the NCU 2 disconnects the communication line and waits for redialing. Meanwhile, when the destination has responded to the incoming call, the process proceeds onto step ST18. At step ST18, a pre-message protocol of the facsimile transmission is executed. That is, as widely known, a probing of the communication line is carried out, and a symbol rate and a data rate or the like are decided. Further, if the RF-ID tag 23 stores a symbol rate and a data rate of previous communication, a value of the symbol rate and the data rate of the previous communication can be used. Then, the process proceeds onto step ST19.

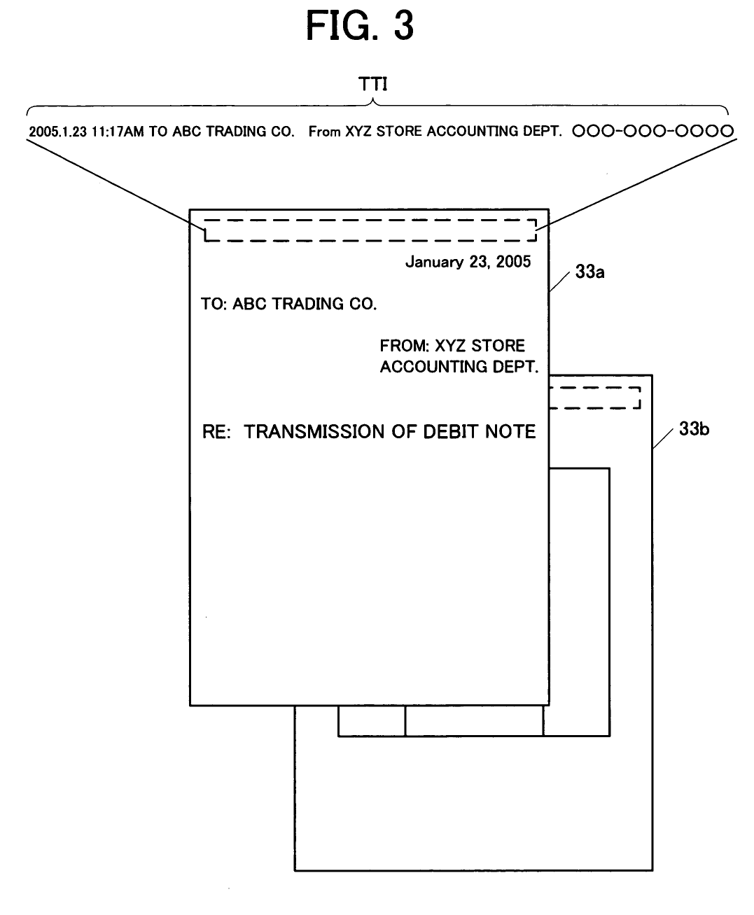

At step ST19, a cover page embedded with a TTI image is transmitted. Next, the process proceeds onto step ST20. At step ST20, image data of an original document embedded with a TTI image is transmitted. FIG. 3 illustrates a cover page 33a and an original document image 33b. Next, the process proceeds onto step ST21.

At step ST21, a determination is carried out as to a presence or an absence of a next page of the original document. In case of a presence of a next page, the process returns to step ST20 and image data of an original document of a next page embedded with a TTI image is transmitted. Meanwhile, in case of an absence of a next page, the process proceeds onto step ST22. At step ST22, a post-message protocol of facsimile transmission, such as transmission of a Return To Control (RTC) signal, is executed. Then, at step ST23, a communication line is disconnected and the process ends.

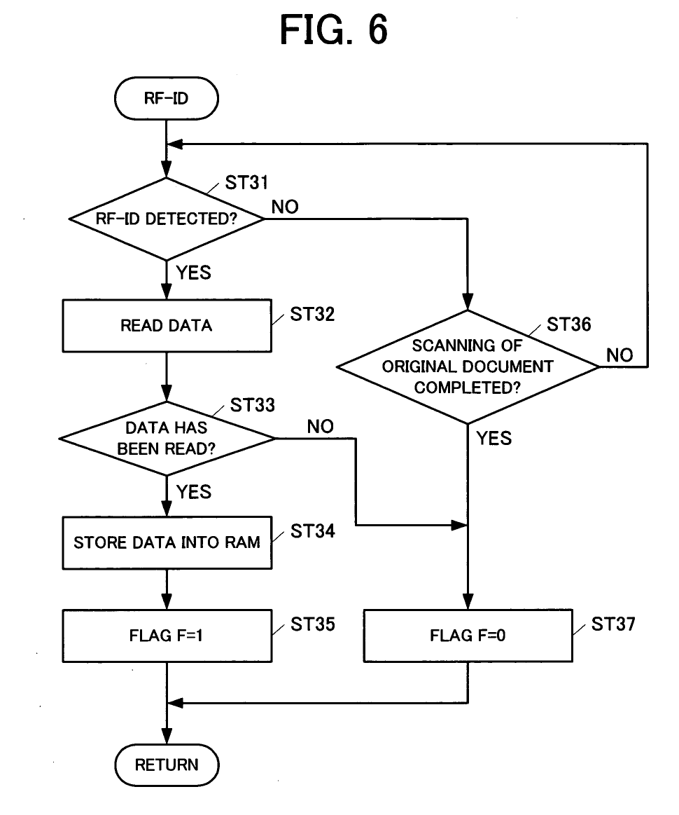

When the scanner 9 scans an image of an original document, the RF-ID reader 19 electromagnetically scans the stored data of the RF-ID tag 32 attached on the original document 31. With reference to the flowchart of FIG. 6, a description will be made of a process carried out in this case.

First, at step ST31, a determination is carried out as to whether or not the RF-ID tag 32 has been detected. The RF-ID reader 19 emits a radio wave and applies a response energy to the RF-ID tag 32. When the RF-ID reader 19 receives the radio wave from the RF-ID tag 32, the MPU 1 determines that the RF-ID tag 32 has been detected. When the RF-ID tag 32 has been detected, the process proceeds onto step ST32. Meanwhile, when the RF-ID tag 32 has not been detected, the process proceeds onto step ST36. At step ST32, the RF-ID reader 19 reads the data of the RF-ID tag 32. Next, the process proceeds onto step ST33. At step ST33, a determination is carried out as to whether or not the data has been read. That is, a determination is carried out as to whether or not the RF-ID reader 19 has successfully demodulated the data in accordance with the radio wave emitted from the RF-ID tag 32. When the data has been read successfully by the RF-ID reader 19, the process proceeds onto step ST34. Meanwhile, when the data fails to be read by the RF-ID reader 19, the process proceeds onto step ST37.

At step ST34, the data read from the RF-ID tag 32 is stored into the RAM 5. Specific examples of the data are “destination”, “subject” and “transmitter”. Next, the process proceeds onto step ST35. At step ST35, the flag F is set at “1”.

At step ST36, a determination is carried out as to whether or not a scanning of the original document has been completed. When the scanning of the original document has not been completed, the process returns to step ST31 and the detection process of the RF-ID tag 32 is continued. Meanwhile, when the scanning of the original document has been completed, the process proceeds onto step ST37. At step ST37, including a case whether the data of the RF-ID tag 32 fails to be scanned at step ST33, the flag F is set at “0”. Then, the process returns to a main routine.

Further, the above-described preferred embodiment of the present invention has been described based on facsimile communication by the ITU-T Recommendation T.30. However, the present invention is not limited to the above-described facsimile communication. The present invention can be applied to Internet facsimile transmission in which an image file is attached to electronic mail. The Tagged Image File Format (TIFF), the Joint Photographic Experts Group (JPEG), the Graphic Interchange Format (GIF), the Portable Document Format (PDF) or the like can be applied as a format of an image file. For example, created electronic mail is transmitted to a mail server (not illustrated) via the LAN-I/F 12 by using the Simple Mail Transfer Protocol (SMTP).

Instead of just retrieving data from the RF-ID tag, a date and time of transmission and a transmission result can be written into the RF-ID tag. Further, the transmission result includes a form and a method of communication used and a communication speed (a symbol rate, a data rate), in addition to a success or a failure of the transmission. Accordingly, a confirmation can be made later on as to whether or not the original document has been transmitted successfully to the destination or under which communication method the original document has been transmitted.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the invention.

What is claimed is:

1. An image data transmission device, comprising:
a Radio Frequency Identification (RF-ID) tag associated with an original document;
an RF-ID reader which retrieves data from the RF-ID tag;
a scanner which optically scans the original document and outputs image data;
a conversion unit which converts the data retrieved from the RF-ID tag by the RF-ID reader into image data;
an adding unit which adds the image data converted by the conversion unit to the image data output from the scanner; and
a transmission unit which transmits the image data generated by the adding unit.

2. The image data transmission device according to claim 1, further comprising a cover page generating unit which generates image data of a cover page that is independent from a page of the original document in accordance with the data retrieved from the Radio Frequency Identification (RF-ID) tag,
wherein the adding unit adds the image data generated by the cover page generating unit to the image data of the original document.

3. The image data transmission device according to claim 1, further comprising a transmission terminal identifier generating unit which generates image data of a transmission terminal identifier in accordance with the data retrieved from the Radio Frequency Identification (RF-ID) tag,
wherein the adding unit adds the image data generated by the transmission terminal identifier generating unit to the image data of the original document.

4. The image data transmission device according to claim 1, wherein the Radio Frequency Identification (RF-ID) tag has an adhesive surface and is attached onto the original document.

5. The image data transmission device according to claim 1, wherein the Radio Frequency Identification (RF-ID) tag has a storage device, and information specifying a transmission destination is stored at least in the storage device.

6. The image data transmission device according to claim 1, further comprising:
an electronic mail generating unit which generates electronic mail to which the image data generated by the adding unit is attached; and
a second transmission unit which transmits the electronic mail generated by the electronic mail generating unit.

7. The image data transmission device according to claim 1, further comprising a conversion unit which converts the image data into a file format capable of being used by a computer.

8. An image data transmission device, comprising:
means for storing information to be attached to an original document;
means for retrieving the stored information wirelessly;
means for converting the retrieved information into first image data;
means for scanning an image of the original document and outputting second image data;
means for adding the first image data to the second image data and generating third image data; and
means for transmitting the third image data.

9. The image data transmission device according to claim 8, further comprising means for editing the first image data as a cover page that is independent from a page of the second image data.

10. The image data transmission device according to claim 8, further comprising means for adding the first image data as a transmission terminal identifier to the second image data and generating the third image data.

11. The image data transmission device according to claim 8, further comprising means for transmitting the third image data to a destination via a public switched telephone network by facsimile communication.

12. The image data transmission device according to claim 8, further comprising:
means for generating electronic mail attached with the third image data; and
means for transmitting the electronic mail to a destination.

13. The image data transmission device according to claim 12, further comprising means for converting the third image data into a file format capable of being used by a computer.

14. The image data transmission device according to claim 8, further comprising means for writing information relating to a transmission result by a radio wave into the means for storing the information.

15. An image data transmission method, comprising:
attaching a Radio Frequency Identification (RF-ID) tag to an original document;
retrieving transmission information from the RF-ID tag;
generating first image data from the transmission information;
generating second image data by scanning an image of the original document;
generating third image data by adding the first image data to the second image data; and
transmitting the third image data.

16. The image data transmission method according to claim 15, further comprising generating the first image data that is independent from a page of the original document in accordance with the transmission information.

17. The image data transmission method according to claim 15, further comprising:
generating a transmission terminal identifier as the first image data in accordance with the transmission information; and
generating the third image data by embedding the generated transmission terminal identifier into the second image data.

18. The image data transmission method according to claim 15, further comprising transmitting the third image data by facsimile to a destination via a public switched telephone network.

19. The image data transmission method according to claim 15, further comprising:
converting the third image data into a file format capable of being used by a computer; and
transmitting electronic mail attached with the converted third image data to a destination.

20. The image data transmission method according to claim 15, further comprising writing a transmission result into the Radio Frequency Identification (RF-ID) tag by a radio wave after a transmission of the third image data has been completed.
